(19) United States
(12) Patent Application Publication
(10) Pub. No.: US 2010/0136191 A1
(43) Pub. Date: Jun. 3, 2010

(54) USE OF SACCARIDES IN EXTRACTION OF TEA OR HERBACEOUS PLANTS

(75) Inventors: Libo Geng, Shanghai (CN); Lisa yu Zhou, Shanghai (CN)

Correspondence Address: THE COCA-COLA COMPANY;PATENT & TECHNOLOGY DEPT--NAT 19, P. O. BOX 1734, ATLANTA, GA, 30301, US

(73) Assignee: The Coca-Cola Company, Atlanta, GA (US)

(21) Appl. No.: 12/521,168

(22) PCT Filed: Dec. 26, 2007
(86) PCT No.: PCT/US07/26323

§ 371 Date: Nov. 18, 2009

(30) Foreign Application Priority Data
Dec. 30, 2006 (CN) 200610156175.7

(51) Int. Cl. A23F 3/34

(52) U.S. Cl. 426/435

(57) ABSTRACT

The present invention relates to a use of saccharides in extraction of tea or herbaceous plants. The addition of saccharides before or during the extraction procedure of tea or herbaceous plants can effectively improve the flavor of tea or beverage as made from extract of the tea or herbaceous plants, enhance its aroma, as well as increase the extraction rate of soluble solids of the tea or herbaceous.

### CROSS-REFERENCE TO RELATED APPLICATIONS

This application claims the benefit of Chinese Patent Application 200610156175.7, filed on December 30, 2006.

### TECHNICAL FIELD

The present invention relates to a use of saccharides in the extraction of tea or herbaceous plants.

### BACKGROUND ART

General processes using water as a solvent for extraction of tea or herbaceous plants as raw materials comprise the steps of: pre-treating the raw materials, extracting, cooling, filtrating, mixing, sterilizing, filling, etc. . . . , and are widely employed in industrial production of tea or beverages because of their simple operation and low cost. However, the process of using water as a solvent for extraction of tea or herbaceous plants as raw materials has a number of drawbacks, such as poor product quality, decreased aroma, thin taste, and relatively low extraction rate of soluble solids.

JP Hei 8-116937 discloses an extract production process comprising baking eucommia bark tea, kneading and twisting, and then extracting, thereby improving flavor and enhancing aroma, but the kneading and twisting technologies in this invention, i.e., baking, drying and state of tea, etc. . . . all affect kneading and twisting quality. JP Hei 8-131133 discloses a process of using an alcohol solution in the extraction of the fruiting body of Grifola frondosa, comprising soaking Grifola frondosa material in alcohol for a period of time and then heating and extracting. However, after the extraction in this invention, the extract can hardly be separated from the solvent, and in addition, alcohol is of poor safety because of its low fire point. JP Hei 10-225264 discloses a process comprising adding sucrose esters into the extract and then extracting food and pharmaceutical components, but the sucrose esters remain in the extract after the extraction and the operation is difficult in production. JP Kokai 2002-306111 discloses a process comprising grinding fruits as raw materials, then mixing them with granulated sugar and adding a certain amount of water to extract the effective components in the fruits. However, in this invention the weight ratio of granulated sugar to fruits is not less than 50%, the ratio of stuff (fruits and granulated sugar) to water is greater than 1:5, and cold preservation is needed before extraction. Thus, the application of this process is limited, it is merely suitable for extraction of effective components of fruits by utilizing osmotic pressure generated by high sugar concentration, and has disadvantages such as long production period, unsuitability for continuous production in large scale, etc. . . .

### DISCLOSURE OF INVENTION

The present invention overcomes the drawbacks of the aforementioned technologies in the prior art by providing a method for improving the flavor of tea or beverages made from extracts of tea or herbaceous plants and for enhancing their aroma, and in the meantime, increasing the extraction rate of soluble solids of tea or herbaceous plants in order to meet the market requirements of people that pursue natural, healthy and delicious tea or herbaceous beverages.

In order to solve the aforementioned technical problems, the present invention is implemented through the following technical solutions.

One embodiment of the present invention provides a method for enhancing the aroma and improving the flavor of the extract of tea or herbaceous plants, comprising adding saccharides into extracting-water before or during the extraction procedure in the production of tea or herbaceous plants extract-based beverages, wherein “during the extraction procedure” means “during a period of time from start to end when the raw material to be extracted (tea or herbaceous plants) contacts the extracting-water”, and wherein the production of tea or herbaceous plants extract-based beverages comprises extracting, cooling, filtrating, mixing, sterilizing and filling.

In some embodiments of present invention, said extracting-water refers to treated water which is selected from the group consisting of reverse osmosis water and de-ionized water.

Another embodiment of the present invention provides a method for increasing the extraction rate of soluble solids of tea or herbaceous plants, comprising adding saccharides into extracting-water before or during the extraction procedure in the production of tea or herbaceous plants extract-based beverages, wherein “during the extraction procedure” means “during a period of time from start to end when the raw material to be extracted (tea or herbaceous plants) contacts the extracting-water”, and wherein the production of tea or herbaceous plants extract-based beverages comprises extracting, cooling, filtrating, mixing, sterilizing and filling.

In other embodiments, the saccharides as mentioned in the present invention are monosaccharides, disaccharides, polysaccharides or mixtures thereof In some particular embodiments, the saccharides are selected from granulated sugar, fructose or maltodextrin.

In another embodiment of the present invention, the ratio of saccharides to tea or herbaceous plants to be extracted is from 1:1 to 1:50.

In another embodiment of the present invention, the ratio of tea or herbaceous plants to be extracted to extracting-water is from 1:5 to 1:200, for example, it is from 1:10 to 1:100.

In another embodiment of the present invention, the ratio of tea or herbaceous plants to be extracted to extracting-water is from 1:10 to 1:50.

In another embodiment of the present invention, the ratio of tea or herbaceous plants to be extracted to extracting-water is from 1:10 to 1:100.

In another embodiment of the present invention, the saccharides are added before a batch, semi-continuous or continuous extraction procedure of the tea or herbaceous plants, wherein the term “before the extraction procedure” means “before the raw material to be extracted (tea or herbaceous plants) contacts the extracting-water”, comprising:
adding the saccharides into the extracting-water;
dissolving the saccharides;
adding the tea or herbaceous plants that are ready for extraction; and
starting the extraction procedure.

In another embodiment of the present invention, the saccharides are added before a continuous extraction procedure of the tea or herbaceous plants, wherein the continuous extraction procedure comprises circulation extraction and countercurrent extraction, comprising:
adding the saccharides into the extracting-water;
dissolving the saccharides;
adding the tea or herbaceous plants that are ready for extraction; and
starting the extraction procedure.

In another embodiment of the present invention, the saccharides are added during a continuous extraction procedure of the tea or herbaceous plants, wherein the term “during the extraction procedure” means “during a period of time from start to end when the raw material to be extracted (tea or herbaceous plants) contacts the extracting-water”, and the continuous extraction procedure comprises circulation extraction and countercurrent extraction, comprising:
adding the saccharides and the tea or herbaceous plants to be extracted into the extracting-water; and
starting the extraction procedure.

In another embodiment of the present invention, the tea or herbaceous plants are trunks, leaves, seeds, roots, fruits or mixtures thereof.

The technical effects of the present invention comprise enhancing the aroma of tea or beverages made from extract of tea or herbaceous plants, and improving their flavor, as well as increasing the extraction rate of soluble solids of tea or herbaceous plants.

### MODES FOR CARRYING OUT THE INVENTION

The present invention addresses the demand in the market for healthy and delicious tea or herbaceous beverages by providing methods for improving the flavor and enhancing the aroma of tea or beverages made from extracts of tea or herbaceous plants while increasing the extraction rate of soluble solids from tea or herbaceous plants.

The methods of the invention comprise the addition of saccharides into extracting-water before or during the extraction procedure in the production of tea or herbaceous plants extract-based beverages, wherein “during the extraction procedure” means “during a period of time from start to end when the raw material to be extracted (tea or herbaceous plants) contacts the extracting-water”, and wherein the production of tea or herbaceous plants extract-based beverages comprises extracting, cooling, filtrating, mixing, sterilizing and filling. In some embodiments of the present invention, the tea or herbaceous plants are trunks, leaves, seeds, roots, fruits or mixtures thereof. The saccharides used are selected from the group of: monosaccharides, disaccharides, polysaccharides and mixtures thereof. In some particular embodiments, the saccharides are granulated sugar, fructose or maltodextrin.

The extracting-water refers to treated water which is selected from the group consisting of reverse osmosis water and de-ionized water.

One embodiment of the invention provides a method for enhancing the aroma and improving the flavor of the extract of tea or herbaceous plants, comprising adding saccharides into extracting-water before or during the extraction procedure of tea or herbaceous plants.

Another embodiment of the invention provides a method for increasing the extraction rate of soluble solids of tea or herbaceous plants, comprising adding saccharides into extracting-water before or during the extraction procedure of tea or herbaceous plants.

The ratio of the saccharides to the tea or herbaceous plants to be extracted ranges from 1:1 to 1:50. The ratio of the tea or herbaceous plants to be extracted to the extracting-water ranges from 1:5 to 1:200. In some embodiments of the invention, the ratio of the tea or herbaceous plants to be extracted to the extracting-water ranges from 1:10 to 1:100. In other embodiments of the present invention, the ratio of the tea or herbaceous plants to be extracted to the extracting-water is from 1:10 to 1:50, while in other embodiments, the ratio is from 1:10 to 1:100.

In some embodiments of the invention, the saccharides are added before a batch, semi-continuous or continuous extraction procedure of the tea or herbaceous plants, that is before the raw material to be extracted (tea or herbaceous plants) contacts the extracting-water. In the embodiments where the saccharides are added before a continuous extraction procedure, the continuous extraction procedure comprises circulation extraction and countercurrent extraction. In all of these embodiments, the method comprises adding the saccharides into the extracting-water, dissolving the saccharides, adding the tea or herbaceous plants that are ready for extraction, and starting the extraction procedure.

In other embodiments of the invention, the saccharides are added during a continuous extraction procedure of the tea or herbaceous plants, that is, during a period of time from start to end when the raw material to be extracted (tea or herbaceous plants) contacts the extracting-water. The continuous extraction procedure comprises circulation extraction and countercurrent extraction. In these embodiments, the method comprises adding the saccharides and the tea or herbaceous plants to be extracted into the extracting-water and starting the extraction procedure.

The following examples of the present invention provide detailed methods for improving the flavor and enhancing the aroma of tea or beverages made from extracts of tea or herbaceous plants while increasing the extraction rate of soluble solids from tea or herbaceous plants. All the descriptions of the present invention show that the addition of an appropriate amount of saccharides during the extraction procedure of tea or herbaceous plants may effectively improve the flavor and enhance the aroma of extracts of tea or herbaceous plants while increasing the extraction rate of soluble solids from tea or herbaceous plants.

### EXAMPLE 1

### Preparation of a Herbal Beverage

1.1 30 g of red dates and 20 g of longan were weighed, rinsed with clear water, and left trickling to dry for standby;
1.2 950 g of extracting-water was heated to 90° C.;
1.3 25 g of white sugar of a total of 40 g of white sugar in a formula were added into the hot water and dissolved;
1.4 the red dates and longan were added into the hot water and extracted for 60 minutes;
1.5 the extract liquid was cooled, and centrifuged to obtain a relatively clear extract liquid;
1.6 the residual white sugar (15 g) was added in the extract liquid according to the formula, and water was added to reach a volume of 1000 ml;
1.7 the beverage of the step 1.6 was sterilized and filled into bottles to obtain the final product (Brix 4.0);
1.8 the resulted final product was tested, and the results indicated that both the aroma and the mouth-feel were improved in comparison with products made by other processes;
1.9 the solid content of the resulted extract liquid of step 1.5 was measured, and was found to be increased by 9% in comparison with extract liquid made by other processes.

### EXAMPLE 2

### Preparation of a Chrysanthemum-Green Tea Beverage

2.1 1000 g of extracting-water were heated to 80° C.;
2.2 5 g of white sugar of a total of 120 g of white sugar in a formula were added into the hot water and dissolved;
2.3 15 g of green tea and 5 g of chrysanthemum were added into the hot water, and extracted for 15 minutes;
2.4 the extract liquid was cooled, and centrifuged to obtain a relatively clear extract liquid;
2.5 the residual white sugar (115 g) was added in the extract liquid according to the formula, and water was added to reach a volume of 3000 ml (Brix 4.0);
2.6 the above beverage was sterilized and filled into bottles to obtain the final product;
2.7 the final product was tested, and the results indicated that both the aroma and taste were improved in comparison with products as made by other processes, while the bitter and astringent tastes were reduced significantly.

### EXAMPLE 3

### Preparation of Red Date-Tea

3.1 1000 g of extracting-water were heated to 95° C.;
3.2 15 g of white sugar out of a total of 80 g of white sugar in a formula were added into the hot water and dissolved;
3.3 15 g of red tea and 4 g of red dates were added into a countercurrent extraction apparatus, and extracted with the hot water with dissolved sugar for 30 minutes;
3.4 the extract liquid was cooled and centrifuged to obtain a relatively clear extract liquid;
3.5 the residual white sugar (65 g) was added into the extract liquid according to the formula, and water was added to reach a volume of 2000 ml (Brix 4.0);
3.6 the above beverage was sterilized and filled into bottles to obtain the final product;
3.7 the final product was tested, and indicated that both the aroma of red dates and the overall taste were improved in comparison with products as made by other processes, while the bitter and astringent tastes of tea were reduced significantly;
3.8 the solid content of the resulted extract liquid of step 3.4 was measured and found to be increased by 2.6% in comparison with extract liquid made by other processes.

### EXAMPLE 4

### Comparison Results of Extraction Yield and Sensory Evaluation of a Herbal Beverage Prepared by Adding Saccharides Before the Extraction Procedure

### 1. Comparison of the Extraction Yield on the Solid Content of a Herbal Beverage

1) comparison formula 1: 100 g of raw materials (60 g red date, 40 g longan) were added in 1900 g of treated water at 95° C. and extracted for 60 minutes. The extract liquid was cooled to below 15° C. and centrifuged under 5000 rpm for 15 minutes to obtain a relatively clear comparison extract liquid 1. Its solid content was measured, and then 160 g of granulated sugar were added to said relatively clear comparison extract liquid 1 and the volume was adjusted to 2000 ml (Brix 8.0).
2) formula 1: 30 g of granulated sugar were added into 1900 g of treated water at 95° C. and dissolved, then 100 g of raw material (60 g red date, 40 g longan) were added and extracted for 60 minutes. The extract liquid was cooled to below 15° C. and centrifuged under 5000 rpm for 15 minutes to obtain a relatively clear extract liquid 1, and its solid content was measured. Then, 130 g of granulated sugar were added to the extract liquid 1, the volume was adjusted to 2000 ml (Brix 8.0) to obtain final product formula 1, and then the sensory evaluation made.
3) formula 2: 50 g of granulated sugar were added into 1900 g of treated water at 95° C. and dissolved, then 100 g of raw material (60 g red date, 40 g longan) were added and extracted for 60 minutes. The extract liquid was cooled to below 15° C. and centrifuged under 5000 rpm for 15 minutes to obtain a relatively clear extract liquid 2, and its solid content was measured. Then, 110 g of granulated sugar were added to the extract liquid 2, the volume was adjusted to 2000 ml (Brix 8.0) to obtain final product formula 2, and then the sensory evaluation was made.
4) formula 3: 30 g of fructose were added into 1900 g of treated water at 95° C. and dissolved, then 100 g of raw material (60 g red date, 40 g longan) were added and extracted for 60 minutes. The extract liquid was cooled to below 15° C. and centrifuged under 5000 rpm for 15 minutes to obtain a relatively clear extract liquid 3, and its solid content was measured. Then, 130 g of granulated sugar were added to the extract liquid 3 and the volume was adjusted to 2000 ml (Brix 8.0) to obtain final product formula 3, and then the sensory evaluation was made.

The comparison results are shown in Table 1.

TABLE 1
Comparison of extraction yield of solid content of herbal beverage extract
liquid

| | | | | | comparison |
|---|---|---|---|---|---|
| | | | | | extract |
| | Unit | extract liquid 1 | extract liquid 2 | extract liquid 3 | liquid 1 |
| Raw material | g | 100 | 100 | 100 | 100 |
| (60 g red date, | | | | | |
| 40 g longan) | | | | | |
| Saccharides | g | 30 (granulated | 50 (granulated | 30 (fructose) | 0 |
| | | sugar) | sugar | | |
| Water | g | 1900 | 1900 | 1900 | 1900 |
| Weight of extract | g | 1494.5 | 1530 | 1530 | 1492 |
| Concentration of | Bx | 2.896 | 4.015 | 2.858 | 0.925 |
| extract | | | | | |
| Yield | % | 15.05 | 14.00 | 14.96 | 13.80 |

Note:
Yield was the dry weight (free of sugar) percentage of actually obtained extract based on the dry weight of raw material.

### 2. Comparison of Sensory Evaluation on Herbal Beverage

With respect to the final product formula 1, formula 2, formula 3 and the comparison formula 1 prepared from extract liquid 1, extract liquid 2, extract liquid 3 and comparison liquid 1 as above, respectively, evaluations were made by a 5-score method in terms of aroma, taste, mouth-feel, and sweetness intensity.

Said 5-score method is a numerical scale that is commonly used in sensory evaluation. The method consists of a series of numbers ranging from low to high, that are understood to represent successive levels of quality degrees of a characteristic. For example, Score 1 means extremely weak, Score 2 means weak, Score 3 means normal, Score 4 means strong, and Score 5 means extremely strong (see, <Food sensory evaluation>, Chemistry Industry Press, M A Yongqiang, H A N Chunran, L I U Jingbo, Ed, August 2005, 1^{st} Edition).

The results are shown in Table 2.

TABLE 2
Comparison of sensory evaluation on the herbal beverages

| | | | | comparison |
|---|---|---|---|---|
| | formula 1 | formula 2 | formula 3 | formula 1 |
| aroma intensity | 3.78 | 2.61 | 2.89 | 2.61 |
| taste intensity | 3.00 | 2.89 | 2.78 | 2.67 |
| mouth-feel intensity | 2.22 | 1.89 | 1.72 | 1.50 |
| sweetness intensity | 2.72 | 2.83 | 2.22 | 2.22 |

The above results indicate:
(1) when the raw materials were extracted with water, the addition of saccharides (granulated sugar, fructose) promoted the dissolution of effective components, effectively enhanced aroma and the dissolution of soluble solid substances, thereby increasing the mouth-feel and aroma of the product and improving the quality of the product;
(2) the addition of saccharides facilitated the dissolution of soluble solid substances, but the dissolution increment was not in direct proportion to the dosage.

### EXAMPLE 5

### Comparison Results of Extraction Yield and Sensory Evaluation of a Chrysanthemum-Green Tea Beverage by Adding Saccharides before the Extraction Procedure

Part A When sucrose was used, the results were as follows:

### 1. Comparison of the Extraction Yield on Solid Content of a Chrysanthemum-Green Tea Beverage

1) comparison formula 2: 20 g of raw materials (chrysanthemum 5 g, green tea leave 15 g) were added in 1000 g of treated water at 80° C. and extracted for 15 minutes. The extract liquid was cooled to below 15° C. and centrifuged under 5000 rpm for 15 minutes to obtain a relatively clear comparison extract liquid 2, and its solid content was measured. Then, 120 g of granulated sugar were added to said relatively clear comparison extract liquid 2 and the volume was adjusted to 3000 ml (Brix 4.0).
2) formula 4: 5 g of granulated sugar were added into 1000 g of treated water at 80° C. and dissolved, then 20 g of raw materials (chrysanthemum 5 g, green tea leave 15 g) were added and extracted for 15 minutes. The extract liquid was cooled to below 15° C. and centrifuged under 5000 rpm for 15 minutes to obtain a relatively clear extract liquid 4, and its solid content was measured. Then, 115 g of granulated sugar were added to the extract liquid 4 and the volume was adjusted to 3000 ml (Brix 4.0) to obtain final product formula 4, and then a sensory evaluation was made.
   The results of the extraction are shown in Table 3.

TABLE 3
Comparison of the extraction yield of solid content of a
chrysanthemum-green tea beverage extract liquid by adding sucrose

| | | | comparison |
|---|---|---|---|
| | Unit | extract liquid 4 | extract liquid 2 |
| Raw | g | 20 | 20 |
| materials (chrysanthemum | | | |
| 5 g, green | | | |
| tea leave 15 g) | | | |
| Saccharides | g | 5 (granulated sugar) | 0 |
| Water | g | 1000 | 1000 |
| Weight of extract | g | 894.5 | 878.5 |
| liquid | | | |
| Concentration of | Bx | 1.254 | 0.753 |
| extract liquid | | | |
| Yield | % | 33.60 | 33.07 |

Note: Yield was the dry weight (free of sugar) percentage of actually obtained extract based on the dry weight of raw material.

### 2. Comparison of Sensory Evaluation on a Chrysanthemum-Green Tea Beverage

With respect to final product formula 4 and comparison formula 2 prepared from extract liquid 4, and comparison extract liquid 4 as above, respectively, the evaluation was made by the 5-score method in terms of aroma, overall taste, and bitter/astringent taste.

The results are shown in Table 4.

TABLE 4
Comparison of sensory evaluation on a
chrysanthemum-green tea beverage

| | formula 4 | comparison formula 2 |
|---|---|---|
| aroma | 2.9 | 3.2 |
| overall taste | 3.6 | 2.7 |
| bitter/astringent taste | 2.6 | 2.7 |

Part B When maltodextrin was used, the results were as follows:

### 3. Comparison of Extraction Yield on Solid Content of a Chrysanthemum-Green Tea Beverage

1) comparison formula 3: 20 g of raw materials (chrysanthemum 5 g, green tea leave 15 g) were added in 1000 g of treated water at 80° C. and extracted for 15 minutes. The extract liquid was cooled to below 15° C. and centrifuged under 5000 rpm for 15 minutes to obtain a relatively clear comparison extract liquid 3. Its solid content was measured, and then the volume of said relatively clear comparison extract liquid 3 was adjusted to 2000 ml (Brix 0.5).
2) formula 5: 0.8 g of maltodextrin was added into 1000 g treated water at 80° C. and dissolved, then 20 g of raw materials (chrysanthemum 5 g, green tea leave 15 g) were added and extracted for 15 minutes. The extract liquid was cooled to below 15° C. and centrifuged under 5000 rpm for 15 minutes to obtain a relatively clear extract liquid 5, and its solid content was measured. Then, the volume of extract liquid 5 was adjusted to 2000 ml (Brix 0.5) to obtain final product formula 5, and then the sensory evaluation was made.

The results of the extraction are shown in Table 5.

TABLE 5
Comparison of the extraction yield of solid content of
a chrysanthemum-green tea beverage extract liquid by
adding maltodextrin

| | | | comparison extract |
|---|---|---|---|
| | Unit | extract liquid 5 | liquid 3 |
| Raw materials | g | 20 | 20 |
| (chrysanthemum 5 g, | | | |
| green tea leave 15 g) | | | |
| Saccharides | g | 0.8 maltodextrin | 0 |
| Water | g | 1000 | 1000 |
| Weight of extract liquid | g | 882.5 | 878.5 |
| Concentration of extract | Bx | 0.823 | 0.753 |
| liquid | | | |
| Yield | % | 30.10 | 30.07 |

Note:
Yield was the dry weight (free of sugar) percentage of actually obtained extract based on the dry weight of raw material.

### 4. Comparison of the Sensory Evaluation on a Chrysanthemum-Green Tea Beverage

With respect to final product formula 5 and comparison formula 3 prepared from extract liquid 5, and comparison extract liquid 3 as above, respectively, the evaluation was made by the 5-score method in terms of aroma, overall taste, and bitter/astringent taste.

The results are shown in Table 6.

TABLE 6
Comparison of sensory evaluation on
a chrysanthemum-green tea beverage

| | formula 5 | comparison formula 3 |
|---|---|---|
| aroma | 3.5 | 3.2 |
| overall taste | 3.6 | 3.1 |
| bitter/astringent taste | 3.0 | 3.4 |

The above results indicate:
(1) when the raw materials were extracted with water, the addition of saccharides (granulated sugar, maltodextrin) promoted the dissolution of effective components, effectively enhanced aroma (in the case of maltodextrin) and the dissolution of soluble solid substances;
(2) the addition of saccharides effectively reduced the bitter and astringent feel, increased the taste, and improved the quality of the product; and
(3) the addition of saccharides facilitated the dissolution of soluble solid substances, but the dissolution increment was not in direct proportion to the dosage.

### EXAMPLE 6

### Comparison Results of the Extraction Yield and Sensory Evaluation of a Red Date-Tea Beverage by Adding Saccharides During the Extraction Procedure

### 1. Comparison of the Extraction Yield on Solid Content of a Red Date-Tea Beverage

1) comparison formula 4: 1000 g of treated water at 95° C. and 19 g of raw materials (red tea 15 g, red date 4 g) were added inversely in countercurrent extraction equipment and the extraction was conducted for 30 minutes. The extract liquid was cooled to below 15° C. and centrifuged under 5000 rpm for 15 minutes to obtain a relatively clear comparison extract liquid 4. Its solid content was measured, and then 80 g of granulated sugar were added to said relatively clear comparison extract liquid 4 and the volume was adjusted to 2000 ml (Brix 4.0).
2) formula 6: 15 g of granulated sugar were added in 1000 g of treated water at 95° C. and dissolved to obtain solution A. Then, the solution A and 19 g of raw materials (red tea 15 g, red date 4 g) were added inversely in a countercurrent extraction equipment and the extraction was conducted for 30 minutes. The extract liquid was cooled to below 15° C., centrifuged under 5000 rpm for 15 minutes to obtain a relatively clear extract liquid 6, and its solid content was measured. Then, 65 g of granulated sugar were added to the extract liquid 6 and the volume was adjusted to 2000 ml (Brix 4.0) to obtain final product formula 6. Then, the sensory evaluation was made.

The results of extraction are shown in Table 7.

TABLE 7
Comparison of the extraction yield of solid
content of a red date-tea beverage beverage extract liquid

| | | | Comparison extract |
|---|---|---|---|
| | Unit | Extract liquid 6 | liquid 4 |
| Raw materials | g | 12 | 12 |
| (red tea 15 g, red date 4 g) | | | |
| Saccharides | g | 15 (granulated | 0 |
| | | sugar) | |
| Water | g | 1000 | 1000 |
| Weight of extract liquid | g | 828 | 804 |
| Concentration of extract | Bx | 1.534 | 0.401 |
| liquid | | | |
| Yield | % | 27.58 | 26.87 |

Note:
Yield was the dry weight (free of sugar) percentage of actually obtained extract based on the dry weight of raw material.

### 2. Comparison of the Sensory Evaluation on a Red Date-Tea Beverage

With respect to final product formula 6 and comparison formula 4 prepared from extract liquid 6, and comparison extract liquid 4 as above, respectively, evaluation was made by the 5-score method in terms of aroma, overall taste, and bitter/astringent taste.

The results are shown in Table 8.

TABLE 8
Comparison of sensory evaluation on red date-tea beverage

| | formula 6 | comparison formula 4 |
|---|---|---|
| Aroma | 3.2 | 3.3 |
| Overall taste | 3.5 | 3.6 |
| Bitter and astringent feel | 2.4 | 3.1 |

The results indicate:
(1) when the raw materials were extracted with water, the addition of saccharides (granulated sugar) promoted the dissolution of effective components;
(2) the addition of saccharides effectively reduced the bitter and astringent feel, and improved the quality of product; and
(3) the addition of saccharides facilitated the dissolution of soluble solid substances, but the dissolution increment was not in direct proportion to the dosage.

All descriptions and examples in the invention are for references. The present invention is illustrated in detail in the examples. All examples are improvable in aspect of technology as long as the main concept of the present invention is complied with.

1. A method for improving the flavor of an extract of tea or herbaceous plants, comprising adding saccharides into extracting-water before or during the extraction procedure of tea or herbaceous plants, wherein the extraction procedure refers to a period of time from the start to end when the raw material to be extracted contacts the extracting-water, wherein the raw material to be extracted is selected from the group consisting of: tea or herbaceous plants.

2. A method for enhancing the aroma of an extract of herbaceous plants, comprising adding saccharides into extracting-water before or during the extraction procedure of herbaceous plants, wherein the extraction procedure refers to a period of time from the start to end when the raw material to be extracted contacts the extracting-water, wherein the raw material to be extracted is selected from the group consisting of: herbaceous plants.

3. A method for reducing the bitter feel of an extract of tea, comprising adding saccharides into extracting-water before or during the extraction procedure of tea, wherein the extraction procedure refers to during a period of time from the start to end when the raw material to be extracted contacts the extracting-water, wherein the raw material to be extracted is selected from the group consisting of: tea.

4. A method for increasing the extraction rate of soluble solids of tea or herbaceous plants, comprising adding saccharides into extracting-water before or during the extraction procedure of tea or herbaceous plants, wherein the extraction procedure refers to a period of time from the start to end when the raw material to be extracted (tea or herbaceous plants) contacts the extracting-water, wherein the raw material to be extracted is selected from the group consisting of: tea or herbaceous plants.

5. The method according to any one of claims 1 to 4, characterized in that the saccharides are monosaccharides, disaccharides, polysaccharides or mixtures thereof.

6. The method according to any one of claims 1 to 4, characterized in that the ratio of the saccharides to the raw material to be extracted is from 1:1 to 1:200.

7. The method according to any one of claims 1 to 4, characterized in that the ratio of the saccharides to the raw material to be extracted is from 1:1 to 1:5.

8. The method according to any one of claims 1 to 4, characterized in that the ratio of the saccharides to the raw material to be extracted is from 1:2 to 1:4.

9. The method according to any one of claims 1 to 4, characterized in that the ratio of the raw material to be extracted to the extracting-water is from 1:5 to 1:100.

10. The method according to any one of claims 1 to 4, characterized in that the ratio of the raw material to be extracted to the extracting-water is from 1:10 to 1:50.

11. The method according to any one of claims 1 to 4, characterized in that the saccharides are added before a batch, semi-continuous or continuous extraction procedure, wherein the term “before the extraction procedure” means “before the raw material to be extracted contacts the extracting-water”, comprising:
adding the saccharides into the extracting-water;
dissolving the saccharides;
adding the raw material to be extracted that is ready for extraction;
starting the extraction procedure.

12. The method according to any one of claims 1 to 4, characterized in that the saccharides are added before a continuous extraction procedure, wherein the continuous extraction procedure comprises circulation extraction and countercurrent extraction, comprising:
adding the saccharides into the extracting-water;
dissolving the saccharides;
adding the raw material to be extracted that is ready for extraction;
starting the extraction procedure.

13. The method according to any one of claims 1 to 4, characterized in that the saccharides are added during a continuous extraction procedure, wherein the term “during the extraction procedure” means “during a period of time from the starting to end when the raw material to be extracted contacts the extracting-water”, and the continuous extraction procedure comprises circulation extraction and countercurrent extraction, comprising:
adding the saccharides and the raw material to be extracted into the extracting-water;
starting the extraction procedure.

14. The method according to any one of claims 1 to 4, characterized in that the raw material to be extracted are trunks, leaves, seeds, roots, fruits or mixtures thereof.

15. The method according to any one of claim 1, 3 or 4, wherein the extraction procedure takes place in the production of tea extract-based beverages, wherein the production of tea extract-based beverages comprises extracting, cooling, filtrating, mixing, sterilizing and filling.

16. The method according to any one of claim 1, 2 or 4, wherein the extraction procedure takes place in the production of herbaceous plants extract-based beverages, wherein the production of herbaceous plants extract-based beverages comprises extracting, cooling, filtrating, mixing, sterilizing and filling.
